(19) United States
(12) Patent Application Publication
(10) Pub. No.: US 2023/0408664 A1
(43) Pub. Date: Dec. 21, 2023

(54) METHOD FOR A ONE-SIDED RADIO-BASED DISTANCE MEASUREMENT

(71) Applicant: LAMBDA:4 ENTWICKLUNGEN GMBH, Hamburg (DE)

(72) Inventor: Rönne REIMANN, Hamburg (DE)

(73) Assignee: LAMBDA:4 ENTWICKLUNGEN GMBH, Hamburg (DE)

(21) Appl. No.: 18/250,835

(22) PCT Filed: Nov. 4, 2020
(86) PCT No.: PCT/EP2020/081016

§ 371 Date: Jun. 23, 2023

(51) Int. Cl. G01S 11/08

(52) U.S. Cl. CPC G01S 11/08

(57) ABSTRACT

The invention relates to a method for a one-sided radio-based distance measurement. The inventor has ascertained that, surprisingly, between time-synchronized objects, in particu-lar with a phase-coherent frequency change, it is possible to ob-viate the need for a transmission direction. This is achieved by a method for measuring distances between two objects, wherein the two objects are time-synchronized to IO ns or better, a first and/or second of the two objects emits signals at multiple frequen-cies, and the distance between the first and second object is deter-mined. The invention is characterized in that the method includes the process of deciding whether/which signals of the first object or the second object are used, in particular on the basis of at least one estimation or determination of the influence of interference on the reception of both objects.

### TECHNICAL FIELD

The invention relates to a method for one-sided radio-based distance measurement.

### BACKGROUND ART

Determining the distance between two objects based on the exchange of radio signals between the objects is known.

Synchronizing timers in two objects is also known, both via cabled and wireless connections. For example, there is the NTP protocol. Within the scope of a Bluetooth connection, too, a synchronization is provided in which each object has a freely running 28-bit clock with a cycle of 3.2 kHz and each object ascertains its offset relative to a central clock, and corrects the offset on a regular basis. In this case, synchronization with an accuracy of approximately 125 ns is achieved. Improved time synchronization is also known, for example, from DE1 1 201 4004426T5 or “Synchronization in radio Sensor Networks Using Bluetooth,” Casas et al., Third International Workshop on Intelligent Solutions in Embedded Systems, 2005, ISBN: 3-90246303-1. This can be used for saving energy, for example, in that an object is kept ready to receive only in certain time slices, which are known to the other object, in order to send at corresponding times. Synchronization of the clocks is also still possible, at least with one-sided relatively strong interference on the radio channel, although the distance measurement becomes impossible or very inaccurate, or takes a very long time during such interference. Synchronization to a clock-cycle of a received signal at the receiver of the signal must be clearly differentiated from the accuracy of a time synchronization. In this case, there is no synchronization of two clocks at two objects, but rather the receiving object is set such that it is synchronized with the incoming signal. The signal time-of-flight does not play a role here, since for that it is irrelevant when the signal was sent and/or how long it took to be transmitted.

### SUMMARY OF THE INVENTION

In order to speed up the determination of the distance and/or to increase the accuracy of the determination of the distance between two objects and/or in the event of interference in the reception of one of the two objects, it is desirable to carry out the distance determination largely without consideration of the radio signals of one transmission direction. The object of the present invention is to speed up the determination of the distance, to enable this with greater accuracy and/or to enable or improve it even in the event of one-sided interference, respectively, in the radio connection.

Surprisingly, the inventor has identified that it is possible to not consider one transmission direction between time- and/or clock-cycle-synchronized objects, particularly with phase-coherent frequency change. This ensures a more rapid measurement, since the switching times of the transceivers can also be largely disregarded, and enables the distance to be determined even in the event of one-sided strong interference on the radio channel.

The problem is solved by a method for distance determination between two objects, wherein the two objects are time- and/or clock-cycle-synchronized to 10 ns or better, particularly in the range between 10 ns and 100 ps, and wherein a first and/or second of the two objects emits signals at multiple frequencies, and the second and/or first of the two objects receives these signals, and the distance between the first and second object is determined therefrom as well as from the knowledge of the time-points at which features of the signals were emitted, particularly at least one feature per frequency and/or per signal. In this context, only the first object can transmit, and the second object can receive, the signals of the first object, or only the second object can transmit, and the first object can receive, the signals of the second object. Also both can be combined, in particular temporally successively or alternatingly.

Features of the signal are to be understood particularly as changes of the signal, such as change in amplitude, polarization, the emitting antenna (change between antennas), frequency, and/or phase. However, aggregated groups of features can also be used, which augment the robustness of the method in some situations. For example, modulated packets or synchronization characters can be used as groups of features.

In a first embodiment, the invention is characterized in that only the signals that the first object has transmitted or, in particular exclusive or, the signals that the second object has transmitted, are used for determining the distance. In a particular embodiment, this decision can also be made individually for each frequency or can be made individually for frequency groups, frequency spans, or frequency sub-bands. Particularly with transmission conditions that are good on both sides or similar on both sides, signals of both objects can also be used at determined frequencies, frequency groups, frequency spans, or frequency sub-bands, or at all frequencies.

In a further embodiment, the invention is also characterized in that it is decided which signals of the first or second object are used to determine the distance. In a particular embodiment, this decision can also be made individually for each frequency or can be made individually for frequency groups, frequency spans, or frequency sub-bands. Particularly with transmission conditions that are good on both sides or similar on both sides, signals of both objects can also be used at determined frequencies, frequency groups, frequency spans, or frequency sub-bands, or at all frequencies.

In this context, versions in which only the first object transmits as well as those in which only the second object transmits are possible, as well as versions in which both transmit, but only a part of the signals, namely those transmitted by the first object or, in particular exclusive or, those transmitted by the second object, are used for distance determination. Excepted from this are signals for time- or clock-cycle-synchronization that can be used by both objects independently of the decision.

The method contains the decision whether the signals of the first object, or in particular the second object, are used and/or which of the signals of the first or second object are used, the decision resting in each case in particular on the basis of at least one estimate or determination of effects of interferences on the reception at both objects. This decision can be made before or after the transmission of the signals or after the transmission of a part.

Insofar as the speed is to be increased, it is preferred to make the decision as early as possible and to keep the transmission of non-used signals as little as possible, particularly not to send such signals after the decision. If the method is to be embodied in a manner minimally prone to interference, the decision is made only after transmission of the signals of the first object and of the signals of the second object. Transmitted and received signals can be used to make the decision. However, alternatively or additionally, other data or measurements can also be used, such as noise or non-method-signals at the receiver. The knowledge about the general interference level at the place of use of the two partners can also be used for the decision.

Selected for the distance determination are, in particular the first or, in particular exclusive or, of the second object, the reception of which at the respectively other of the two objects was, is, or is foreseen to be, subject to less interference. In a particular embodiment, this decision can also be made individually for each frequency or can be made individually for frequency groups, frequency spans, or frequency sub-bands. Particularly with transmission conditions that are good on both sides or similar on both sides, signals of both objects can also be used at determined frequencies, frequency groups, frequency spans, or frequency sub-bands, or at all frequencies.

For the distance determination are selected, in particular, from among the signals of the first or, in particular exclusive or, of the second object, the reception of which at the respectively other of the two objects was, is, or is foreseen to be, subject to less interference. In a particular embodiment, this decision can also be made individually for each frequency or can be made individually for frequency groups, frequency spans, or frequency sub-bands. Particularly with transmission conditions that are good on both sides or similar on both sides, signals of both objects can also be used at determined frequencies, frequency groups, frequency spans, or frequency sub-bands, or at all frequencies.

The decision is conducted particularly such that not selected and/or not used for the determination are, in particular the signals, particularly of a frequency, of a frequency group or frequency span, or of a frequency sub-band, of the first or, in particular exclusive or, of the second object, the reception of which at the respectively other of the two objects was, is, or is foreseen to be subject to more interference than the signals, in particular of the frequency, of the frequency group or frequency span, or of the frequency sub-band, of the other of the two objects.

The decision is conducted particularly such that selected and/or used for the determination are, in particular the signals, particularly of a frequency, of a frequency group or frequency span, or of a frequency sub-band, of the first or, in particular exclusive or, of the second object, the reception of which at the respectively other of the two objects was, is, or is foreseen to be subject to less interference than the signals, in particular of the frequency, of the frequency group or frequency span, or of the frequency sub-band, of the other of the two objects.

In the case of interference of equal magnitude in the reception of the signals of the first object and of the second object, in particular of a frequency, of a frequency group or frequency span, or of a frequency sub-band, both, one, or none of the signals can be used. Preferably the decision is made based on the magnitude of the interference, in particular compared to other frequencies, frequency groups or frequency spans, or frequency sub-bands, in which first and/or second signals were or are transmitted. In a particularly simple embodiment, in this case either the signals of the first object or the signals of the second object, or none of the signals, are selected and/or used.

The interference can be evaluated based on the signal/noise ratio, the carrier/noise ratio, bit-error-frequency, -probability, symbol-error-frequency, -probability, or other measurement variables or methods for evaluating the signal quality or quality of the transmission channel, for example, such as are also known from EP 0 664 625 A2, for example.

Especially advantageously, the first and/or the second object changes between at least two of the multiple frequencies phase-coherently, or a phase jump arising upon switching at the switching object is measured and is considered in the calculation. The change is realized, in particular, by switching at least one PLL. An even robuster and simpler distance measurement can be implemented thereby, and additional advantages in the use of the signals can be realized in that evaluations based thereupon are simplified.

Phase-coherent switching or changing between two frequencies is understood to mean, particularly, that the phase after the switching is known relative to the phase position before the switching. This is the case when the change of phase when switching is zero, or is equivalent to a previously known or ascertainable value. In this manner, further measurements of the phase at the transmitter can be avoided, and the calculation can be simplified, particularly when frequencies are switched between without phase change. It is advantageous not only for the transmitting object to switch in a phase-coherent manner, but also for the receiving object to do so, in particular a PLL is switched in a phase-coherent manner in each object.

Alternatively, switching can be preferably phase-coherent, but also not, and the change in phase can be determined locally, i.e., particularly at the transmitter before the transmission and/or at the receiver relative to the PLL of the receiver, and this change can be corrected in the calculation.

For example, when the point in time of the phase-coherent change or of the change with measured phase jump at the transmitting object is known, and when the change in the received signal is determined at the receiving object, the time between transmitting and receiving the change is determined, which time represents the signal time-of-flight (ToF), and the phase shift is also determined. The distance can be directly determined from the signal time-of-flight using the speed of light. This, however, is likewise possible modulo the wavelength by using the phase shift. The ambiguity accompanying the phase-based measurement can be reduced by using multiple frequencies. A particularly accurate and robust distance measurement can be realized by combining the signal time-of-flight measurements and phase-based measurements.

Phase-coherent switching between two frequencies is understood to mean, particularly, that the time-point of the switching is determined exactly or is measured, and the phase after the switching is known relative to the phase position before the switching. This is the case when the change of phase when switching is zero, or is equivalent to a previously known value.

The signals are radio signals, in particular.

Moreover, surprisingly, it was established that the distances obtained from the one-sided distance measurement or the distance measurement according to the invention described here, are dependent upon the frequency used for the distance determination when standard commercial transceivers are used, such as the somewhat older cc2500 or the current cc26xx by Texas Instruments or the Kw35/36/37/38 by NXP or the DA1469x by Dialog. In this context, inaccuracies in the transceivers also seem to result in calculated distances that are less than the actual distance, but only with those frequencies whose transmission channel is highly attenuated, such that these can be eliminated from the calculation without issue.

Therefore, it is advantageous for the distance determination not to use signal components of the object whose signals are used for the distance determination, for the distance determination in certain cases, namely to not use such components that lie above an upper power limit and/or to not use such components that lie below a lower power limit. These limits can be predetermined, or can be determined based on the received signals, and particularly can be above or below the mean received power, and can be particularly at least 20% above the mean received power (upper power limit) and/or at least 20% above the mean received power (lower power limit).

Preferably, not taken into account are signal components at frequencies received with less than 40%, or at least signals received with less than 20%, particularly less than 40%, of the mean energy of the signals, and/or signals received with greater than 140%, particularly with greater than 120% of the mean energy.

Advantageously, the lower power limit lies in the range from 5 to 50% of the mean power of the received signals, and/or the upper lower limit lies in the range from 120 to 200% of the mean power of the received signals.

In another embodiment, of the signals, particularly those selected in the decision, the x % of the signals with the smallest received amplitude are sorted out and not used, and/or the y % of the signals with the greatest received amplitude are sorted out and not used. It has been shown to be particularly advantageous when the sum of x and y is not less than 10 and/or does not exceed 75, and/or x lies in the range from 10 to 75, and/or y lies in the range from 20 to 50. In most situations, high accuracy and reliable distance determination can be obtained with these values.

Advantageously, the second or, particularly exclusive or, first object does not transmit any signals for distance determination, and/or the second or the first object, particularly exclusive or, only transmits signals for time- and/or clock-cycle synchronization. This saves energy and method time.

Preferably the first and/or second, or each of the two objects, sends the signals on multiple frequencies successively and/or consecutively, in particular directly consecutively. In particular, when sending is taking place by the first and second object, all signals of the first or of the second object are sent first, then those of the other. Influences of environmental or distance changes, and of movements of one or both objects, can be thus reduced.

Advantageously, at no time does the bandwidth of the signals exceed 50 MHz, particularly 25 MHz. Consequently energy can be saved, interference with other processes can be prevented, and simple components can be used compared to broadband methods.

Preferably, a time- and/or clock-cycle synchronization and/or correction is carried out between the two objects before, after and/or while the method is carried out. This augments the accuracy of the method. Preferably, a drift of the clock of the first and/or second object, or a difference in the drift of the clock of the first and of the second object, is also determined and considered in the distance determination. This augments the accuracy of the method.

Advantageously, the method is carried out such that the frequency spacing between two consecutive frequencies of the multiple frequencies is at least 0.1 MHz and/or a maximum of 10 MHz, and/or the multiple frequencies are at least five frequencies and/or a maximum of 200 frequencies, and/or wherein the multiple frequencies span a frequency band of at least two MHz and/or a maximum of 100 MHz. Thus can a balanced measure be found between bandwidth requirement, which imposes requirements for available frequencies and hardware, and accuracy.

Preferably, the method is carried out such that the accuracy of the distance determination lies in the range from 0.3 m to 3 m, in particular at least for distances in the range from 0 to 50 m. The advantages of the invention are brought to bear particularly in these ranges.

Advantageously, the distance determination is based on ascertaining the signal time-of-flight from the first to the second object, or from the second to the first object, and/or on ascertaining the phase shift of the signals from the first to the second object, or from the second to the first object. However, it is also possible to apply known high-resolution methods, such as MUSIC or CAPON, for example. Advantageously, for each signal received at the second and/or first object, a value proportional to its amplitude, and a phase value, are determined, and from them, in particular, a complex number is determined in each case which is used for the distance determination between the first and the second object. The phase value is determined particularly in that with regard to a plurality of pairs of the signals with adjacent frequency, in each case a phase shift change scaled to a frequency spacing is calculated, i.e., the derivation of the phase shift is calculated on one of the frequencies, or the frequencies, of the pair, and the values obtained therefrom are used for determining the phase and/or argument of the complex number at the respective frequency (which belongs to the value that is proportional to the amplitude), particularly by approximate integration via the frequency. When f=0 Hz, it is not necessary to begin with the integration, but rather it is possible and preferred for an offset common to all phases and/or complex numbers to be used, particularly the lowest frequency of the, particularly the selected, signals. In particular, the phase value and/or the argument of the complex numbers is determined from the signal time-of-flight or signal round-trip-time.

In particular, the scaled phase shift change (dPhase shift(f1, f2)) is obtained by using the formula:

dPhase shift(f1,f2)=a*RTT(f3)*dFrequency(f1,f2)

wherein dFrequency(f1,f2) is the difference between the frequencies f1 and f2, RTT(f3) is double the signal time-of-flight or is the signal round-trip time between the first and second object at one or more frequencies f3, similar to f1 and/or f2, and/or vice versa, and wherein a is a constant, in particular, a equals two-Pi.

In particular, the complex value Z is calculated for a frequency, using:

Amount(Z(f))=(b*Amplitude(f)+offset)

Argument(Z(f))=Sum(dPhase shift(f1,f2)*dFrequency(f1,f2)) via f1 from f0 to f

Thus the phase shift changes are summed with the frequency spacings, from the lowest frequency to the frequency in question, for which the complex number is to be determined.

b and offset are constants and, in particular, b is 1, and in particular, offset is 0. Amplitude(f) is the received amplitude measured at frequency f, or a mean value from multiple amplitudes measured at frequency f and/or frequencies similar to f.

The phase shift is a phase shift upon transmission at the frequency from one object to the other, and back, which occurs as a result of the distance. It can be approximately equated with double the phase shift that occurs upon transmission at the frequency from one object to the other as a result of the distance.

In particular, a matrix, particularly an autocorrelation matrix, is constructed from a plurality of the complex numbers, and the distance is determined by means of this autocorrelation matrix and by means of these known methods, such as MUSIC, CAPON, comparison with, distance calculation to, and/or projection onto, the emitting and/or receiving characteristics. Advantageously, the distance calculation occurs by means of eigenvalue, or eigenvector determination, of the at least one matrix and/or Fourier transformation of the complex values.

Such approaches are advantageous for achieving a reliable determination, particularly with multipath signal propagation.

Advantageously, a mean value is determined from multiple distance determinations, and/or the measurements are averaged in order to determine a distance value.

When a position finding is striven for, it is advantageous to carry out the method according to the invention between a plurality of pairs of objects, wherein in particular one object of each pair is an object that is involved in all pairs, and wherein the ascertained distances of the pairs are used to carry out a mapping and/or position determination of at least one of the objects. In particular, it is then advantageous to take these pair-wise measurements simultaneously.

The problem is also solved by one or two objects, each of which is configured with transmission and receiving means, and a controller, configured for carrying out the method according to the invention.

Advantageously, the objects are parts of a data transmission system, particularly a Bluetooth, WLAN, or radio, data transmission system. Preferably, the signals are signals of the data transmission system, particularly of a data transmission standard, for example a wireless standard, WLAN, or Bluetooth, which signals are used for data transmission according to the data transmission standard.

Advantageously, the signals are transmitted over multiple antenna paths, particularly at least three, particularly with multiple antennas, particularly successively, sent at the sending object and/or received at the receiving object with multiple antennas.

The calculation is done as follows, for example: in the averaging of the measured distances, the measurements of the received signals with less than, e.g., 40% of the mean energy of the received signals, are ignored. Thus measurements on frequencies with strongly attenuated transmission channel are disregarded.

The exact time difference and time drift between the two objects are also ascertained and the reception times of features of the signals whose transmission times are known are measured on n>1 frequencies.

The distance can be determined with the results in various ways, for example:

Calculation 1

Before the summation, the sum (RTTASUM) of all signal times-of-flight in each case is multiplied by the respective amplitude, and the sum (ASUM) of all amplitudes is calculated. The division RTTASUM/ASUM then supplies a usable estimate of the signal time-of-flight, from which a distance can easily be determined.

Calculation 2

All measurements with received amplitude less than 40% of the mean received amplitude are thrown out. Of the remaining signal times-of-flight, the 20% smallest signal times-of-flight and the 50% largest times are thrown out.

The remaining 30% of the signal times-of-flight are averaged. A distance can be directly determined from this.

Calculation 3

All signal times-of-flight or doubled signal times-of-flight (RTT) are converted in each case into a phase shift difference or phase shift derivation:

dPhase shift=2 Pi*(2*Distance)*dFrequency/c RTT=2*Distance/c

dPhase shift=2 Pi*(RTT*c)*dFrequency/c

dPhase shift is a distance-caused phase difference between two frequencies that have the spacing dFrequency. c is the speed of light.

Then, the calculated phase shift changes are summed: sumPh(Fn)=Sum of dPh(F0 . . . Fn).

F0 to Fn are the multiple frequencies.

These summed dPhase shifts each as argument of a complex number with the associated and upon reception determined amplitudes or values proportional thereto as amount of the complex numbers, can then be input as complex values into a Fourier transformation, or a spectral estimate can be performed with them using super-resolution methods in matrices (e.g., MUSIC or CAPON). The spectrum is then the spectrum on various wide paths that the signal travels before it arrives superimposed at the receiving antenna. Here, it is particularly advantageous to use multiple antenna paths for the transmission and to include them in the evaluation.

### BRIEF DESCRIPTION OF THE DRAWINGS

FIG. 1 schematically illustrates two possible method sequences in accordance with the present disclosure.

### DETAILED DESCRIPTION

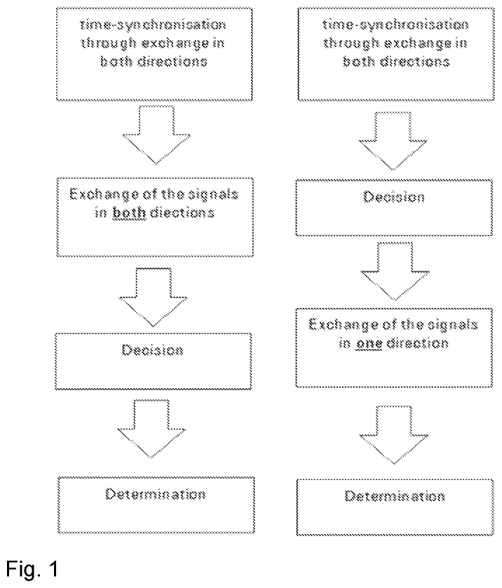

FIG. 1 shows two possible method sequences, purely schematically and not limiting and only as an example. In the left column, the decision is made only after the transmission of the signal of the first and of the second object, while in the right column, this takes place before the transmission of the signals and only one of the objects transmits the signals. Common to both is that the calculation or determination of the distance only considers the signals from one of the objects.

1. A method for distance determination between two objects, wherein the two objects are time or clock-cycle-synchronized to 10 ns or better, and wherein one or both of a first object and a second object of the two objects emits signals at multiple frequencies, and the other of the one or both of the second object and the r first object of the two objects receives the signals at multiple frequencies, and the distance between the first object and the second object is determined therefrom as well as from knowledge of time-points at which features of the signals were emitted, wherein the method includes a decision whether the signals of the first object or the second object are used, or contains the decision as to which of the signals of the first object or the second object are used, wherein the decision rests in each case on the basis of at least one estimate or determination of effects of interferences on the reception at both of the two objects.

2. The method according to claim 1, wherein the one or both of the first object and the second object changes between at least two of the multiple frequencies.

3. The method according to claim 1, wherein for the distance determination, signal components of the one or both of the first object and the second object at frequencies with less than 40%, or at least signals with less than 20% of the mean energy of the signals, or signals with more than 140% of the mean energy, remain unconsidered.

4. The method according to claim 1, wherein the second object or the first object does not send any signals for distance determination, or the second object only sends signals for time or clock-cycle-synchronization.

5. The method according to claim 1, wherein the one or both of the first object and the second object of the two objects emits the signals at multiple frequencies successively or consecutively.

6. The method according to claim 1, wherein at least one time or clock-cycle synchronization or correction is carried out between the two objects before, after or while the method is carried out.

7. The method according to claim 1, wherein a frequency spacing between two consecutive frequencies of the multiple frequencies is one or both of at least 0.1 MHz and a maximum of 10 MHz.

8. The method according to claim 1, wherein accuracy of the distance determination lies in the range from 0.3 m to 3 m.

9. The method according to claim 1, wherein the distance determination is based on ascertaining a signal time-of-flight from the first object to the second object, or from the second object to the first object, or wherein the distance determination is based on ascertaining a phase shift of the signals from the first object to the second object, or from the second object to the first object.

10. The method according to claim 1, wherein a time drift of at least one of the two objects is determined or corrected or is considered in the calculation of the distance.

11. The method according to claim 1, wherein a mean value is determined from multiple spacing determinations.

12. The method according to claim 1, wherein signals received at the second object or the first object with a received power below a predetermined or calculated lower power limit, are not taken into consideration for the distance determination.

13. The method according to claim 1, carried out between a plurality of pairs of objects, and wherein ascertained distances of the pairs are used to carry out a mapping or position determination.

14. An object configured for carrying out the method according to claim 1.

15. The method according to claim 1, wherein at no time does the bandwidth of the signals exceed 50 MHz.

16. The method according to claim 1, wherein the multiple frequencies are at least five frequencies or a maximum of two hundred frequencies or both.

17. The method according to claim 1, wherein the multiple frequencies span a frequency band of at least 2 MHz or a maximum of 100 MHz or both.

18. The method according to claim 1, wherein signals received at the second object or the first object with a power above a predetermined or calculated upper power limit are not taken into consideration for the distance determination.
